(19) United States
(12) Patent Application Publication
(10) Pub. No.: US 2023/0095324 A1
(43) Pub. Date: Mar. 30, 2023

(54) METHOD FOR ASCERTAINING A TORQUE CURVE OF AN INTERNAL COMBUSTION ENGINE OF A HYBRID POWERTRAIN, AND HYBRID POWERTRAIN

(71) Applicant: Schaeffler Technologies AG & Co. KG, Herzogenaurach (DE)

(72) Inventor: Holger Witt, Bühl (DE)

(73) Assignee: Schaeffler Technologies AG & Co. KG, Herzogenaurach (DE)

(21) Appl. No.: 17/800,534

(22) PCT Filed: Jan. 26, 2021
(86) PCT No.: PCT/DE2021/100070

§ 371 Date: Aug. 18, 2022

(30) Foreign Application Priority Data
Feb. 20, 2020 (DE) 10 2020 104 502.6

(51) Int. Cl. G01M 15/04

(52) U.S. Cl. CPC G01M 15/042

(57) ABSTRACT

A method is provided for ascertaining a torque curve of a hybrid powertrain including a first sub-powertrain an internal combustion engine, and a second sub-powertrain, which is separated from the first sub-powertrain by a torsional elasticity and has an electric machine with a rotor (10). A rotational characteristic value of the first sub-powertrain is detected via a sensor arranged on the torsional elasticity. A rotational characteristic value of the rotor is detected via a device engaged with the rotor. An irregularity in operation of the internal combustion engine is determined based on at least one of the rotational characteristic value of the first sub-powertrain or the rotational characteristic value of the rotor. The electric machine is controlled based on the irregularity m operation.

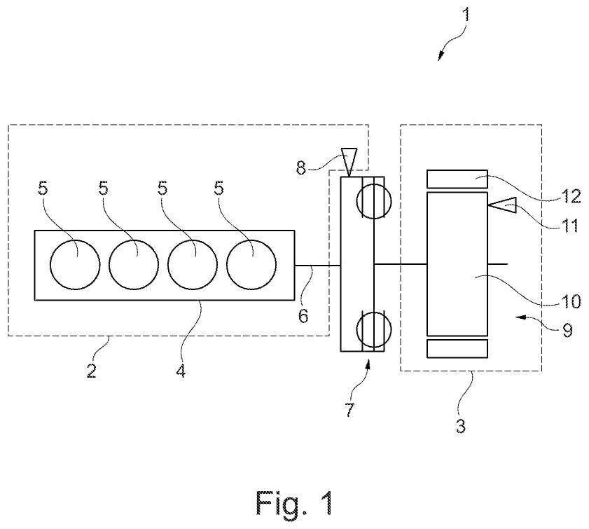

### CROSS-REFERENCE TO RELATED APPLICATIONS

This application is the U.S. National Phase of PCT Appin. No. PCT/DE2021/100070 filed Jan. 26, 2021, which claims priority to DE 102020104502.6 filed Feb. 20, 2020, the entire disclosures of which are incorporated by reference herein.

### TECHNICAL FIELD

The disclosure relates to a method for ascertaining a torque curve, in particular of misfires of an internal combustion engine, which is affected by torsional vibrations, of a hybrid powertrain, and to a hybrid powertrain having a first sub-powertrain, which has the internal combustion engine and a first device for detecting rotational characteristic values of the first sub-powertrain in order to control the internal combustion engine, and a second sub-powertrain, which is separated from the first sub-powertrain by means of a torsional elasticity, and has a second device for detecting rotational characteristic values of a rotor in order to control an electric machine.

### BACKGROUND

Hybrid powertrains with an internal combustion engine affected by torsional vibrations and an electric machine are known. For torsional vibration isolation of the torsional vibrations, a torsional elasticity, for example a torsional vibration damper, can be arranged between the internal combustion engine and the electric machine. In addition, the internal combustion engine can be subject to misfires, which stress the components of the powertrain and can lead to a build-up of torsional elasticity.

A hybrid powertrain is described in WO 2012/025434 A2, in which the internal combustion engine is connected to an electric generator in a torsion-resistant manner. In this case, misfiring of the internal combustion engine is detected by evaluating the current and/or voltage curve at the output of the generator.

DE 102 27 528 A1 discloses a hybrid powertrain with an internal combustion engine and an electric machine connected to it in a torsion-resistant manner by means of a friction clutch, in which misfiring and rough running of the internal combustion engine are detected by means of a rotary encoder of the electric machine.

### SUMMARY

The disclosure provides an exemplary method for identifying misfires in an internal combustion engine in a hybrid powertrain having a torsional elasticity arranged between the internal combustion engine and the electric machine. Furthermore, the disclosure provides an exemplary embodiment of a hybrid powertrain for carrying out a method for identifying misfiring of the internal combustion engine.

The proposed method is used to ascertain a torque curve, in particular misfires, insufficient fuel injections, throttle valve misalignments, valve misalignments and/or the like, of an internal combustion engine affected by torsional vibrations of a hybrid powertrain having a first sub-powertrain with the internal combustion engine and a first device for detecting rotational characteristic values of the first sub powertrain for controlling the internal combustion engine.

A second sub-powertrain contains an electric machine and a second device for detecting rotational characteristic values of a rotor for controlling the electric machine.

The two sub-powertrains are connected to one another by means of a torsional elasticity for damping torsional vibrations of the internal combustion engine. The torsional elasticity can be designed a a torsional vibration damper. The torsional elasticity, for example in the form of a spring device effective in the circumferential direction, for example arc springs arranged to be distributed over the circumference, and thus assigned to the first sub-powertrain can be a primary centrifugal mass and the second sub-powertrain can be assigned a secondary centrifugal mass, for example a rotor mass and/or the like, in order to achieve a dual-mass centrifugal effect. At least one of the two sub-powertrains, in particular the second sub-powertrain, can be assigned a centrifugal pendulum for speed-adaptive torsional vibration damping.

In order to be able to identify a torque curve of the internal combustion engine and, for example, misfires and other irregularities in the operation of the internal combustion engine reliably and quickly, if possible in real time, these are ascertained by comparing the rotational characteristic values of the two devices.

By evaluating the signals of both devices with regard to their rotational characteristic values and the time offset of the change in these, namely, for example, changes in the rotational characteristic values of the internal combustion engine and the electric machine, it is possible to identify which torques are acting on which mass of the sub-powertrains. For example, it can be evaluated whether torque fluctuations are caused by the internal combustion engine or by the output of the hybrid, powertrain.

A comparison of these curves, for example, with target values based on the control of the internal combustion engine or a comparison with actual values of a preceding and subsequent working stroke of cylinders of the internal combustion engine can provide a significant signal for misfiring in real time.

For example, a comparison can be made based on a change in the rotational characteristic values as a result of at least two ignition curves in different cylinders that follow one another in direct succession. For example, three ignition curves can be continuously detected a sliding manner, and an average ignition curve can be compared with the previous and subsequent ignition curve in order to identify a misfire in the event of a significant deviation. Alternatively, ignition curves of the same cylinders can be continuously compared with one another with a short time delay, in order to be able to identify a cylinder-specific misfire in an improved manner in the event of a significant change in an ignition curve.

Alternatively or additionally, the comparison can be carried out using a change in a curve of the rotation parameters during a working cycle of the internal combustion engine and/or a change in the rotation parameters as a result of an ignition curve of at least one cylinder with a stored ignition curve of the at least one cylinder. Such ignition curves can be continuously adapted and evaluated as a function of the control of the internal combustion engine, for example as a function of control variables of the internal combustion engine such as throttle valve position, valve settings and the like.

Alternatively or additionally, the comparison can be carried out using a change in a rotational angle or the curve of the rotational angle of the two sub-powertrains during a working cycle of the internal combustion engine with an unchanged control intervention in the internal combustion engine. If there is no control intervention with a changing torque, it can be assumed that a change in the rotational angle at the torsional elasticity can be traced back to misfiring.

The change in the rotational characteristic values can be detected and ascertained using a state estimator, for example.

The rotational characteristic values can be recorded by the devices, for example as revolutions, rotational speeds, rotational accelerations and/or rotational angles. From these detected rotational characteristic values, the kinetic and/or potential energy, the transmitted torques and/or the speeds and/or rotational accelerations present can be ascertained in the two sub-powertrains and/or in the torsional elasticity using other system-inherent variables such as effective levers, transmission ratios, masses and the like.

A rotary encoder for a crankshaft, for example, can serve as the first device. For this purpose, a sensor ring can be arranged on the torsional elasticity, for example a torsional vibration damper, the increments of which are detected by a stationary sensor. One of one or a plurality of Hall sensors for detecting increments of the rotor for electronic commutation of the electric machine or a sensor device arranged at another location can serve as the second device. Alternatively, a state observer can be used as the second device, which ascertains the rotational characteristic values of the rotor and thus of the second sub-powertrain without sensors using electrical variables induced in the stator of the electric machine, such as induction currents, induction voltages and the like, and thus controls the electric machine.

The proposed hybrid powertrain contains a first sub-powertrain consisting of an internal combustion engine and a first device for detecting rotational characteristic values of a crankshaft of the internal combustion engine, a second sub-powertrain with an electric machine with a rotor and a second device for detecting rotational characteristic values for controlling the electric machine and a torsional elasticity arranged between the crankshaft and the rotor, in particular a torsional vibration damper. The powertrain is operated using the proposed method.

### BRIEF DESCRIPTION OF THE DRAWINGS

The disclosure is explained in more detail with reference to the exemplary embodiment in the single FIGURE. This shows a hybrid powertrain in a schematic representation.

### DETAILED DESCRIPTION

A hybrid powertrain 1 shown schematically contains sub-powertrains 2, 3. The sub-powertrain 2 contains an internal combustion engine 4, here with four cylinders 5, and the crankshaft 6 driven in rotation thereby. A torsional elasticity 7, here a torsional vibration damper such as a dual-mass flywheel, is accommodated on the crankshaft 6, which separates the first sub-powertrain 2 from the second sub-powertrain 3. A device 8 for detecting rotational characteristic values of the crankshaft 6 and thus the control of the internal combustion engine 4 is assigned to the first sub-powertrain 2. For this purpose, a sensor ring is arranged on an input part of the torsional elasticity 7, from the increments of which are detected by a sensor, and corresponding rotational characteristic values, for example the rotational speed, the rotational angle, the rotational acceleration and/or the like, are ascertained from these.

An output part of the torsional elasticity 7 is connected to a rotor 10 of an electric machine 9 in a rotationally locked manner. The electric machine 9 is assigned to the second sub-powertrain 3. The electric machine 9 is controlled by means of a device 11 for ascertaining rotational characteristic values. For example, the device 11 can be formed from one or more Hall sensors, which detect increments from a transmitter device arranged on the rotor 10 or a component connected to it in a rotationally locked manner and use these to ascertain the rotational characteristic values of the rotor 10 in order to use them to control the commutation of the electric machine 9 and to ascertain the position of the rotor 10 as a function of time. Alternatively, the electric machine 9 can be controlled without sensors by means of the device 11 in that the electrical variables of a stator 12 are detected and evaluated by means of a state observer.

In order to quickly and reliably ascertain misfiring of the internal combustion engine 4 in the proposed method, the signals from the devices 8, 11 are jointly evaluated by a controller 13. In this way, the rotational characteristics of the sub-powertrains 2, 3 and thus, with knowledge or modeling of the system properties of the hybrid powertrain 1, influencing variables on the sub-powertrains 2, 3 and the torsional elasticity 7, such as applied torques, rotational acceleration, mass moment of inertia and the like, can be determined or at least estimated.

For example, by comparing the torsional characteristics of the devices 8, 11, the effect of ignition curves before and after the torsional elasticity 7 can be detected and the influence of misfiring on the two sub-powertrains 2, 3 can thereby be detected. For example, the shapes of successive ignition curves of the cylinders 5 can be compared with one another and misfiring can be detected in real time from a change in the shapes. Alternatively or additionally, by observing the rotational angle between the crankshaft 6 and the rotor 10 under otherwise constant conditions, such as without engine intervention in the internal combustion engine 4 and without changing the control of the electric machine 9, misfires can occur due to changes in the rotational angle or changes in the course of the rotational angle during a working stroke or a change in one or more compressed values can be detected, for example, from the course of the rotational angle.

### LIST OF REFERENCE SYMBOLS

1 Hybrid powertrain
2 Sub-powertrain
3 Sub-powertrain
4 Internal combustion engine
5 Cylinder
6 Crankshaft
7 Torsional elasticity
8 Device
9 Electric machine
10 Rotor
11 Device
12 Stator
13 Controller

1. A method for ascertaining a torque curve of a hybrid powertrain including a first sub-powertrain having, an internal combustion engine and a second sub-powertrain, which is separated from the first sub-powertrain by a torsional elasticity and has an electric machine with a rotor, the method comprising:
detecting a rotational characteristic value of the first sub-powertrain via a sensor arranged on the torsional elasticity;
detecting a rotational characteristic value of the rotor via a device engaged with the rotor; and
determining an irregularity in operation of the internal combustion engine based on at least one of the rotational characteristic value of the first sub-powertrain or the rotational characteristic value of the rotor; and
controlling the electric machine based on the irregularity in operation.

2. The method according to claim 1, further comprising:
detecting the rotational characteristic value of the first sub-powertrain for at least two consecutive ignition curves in different cylinders of the internal combustion engine; and
determining the irregularity in operation of the internal combustion engine based on a difference between the rotational characteristic values of the first sub-powertrain for the corresponding the ignition curves exceeding a threshold.

3. The method according to claim 1, further comprising:
detecting the rotational characteristic value of the first sub-powertrain for an ignition curve of at cylinder; and
determining the irregularity in operations of the internal combustion engine based on a difference between the rotational characteristic value of the first sub-powertrain for the ignition curve of the cylinder and a stored ignition curve of the cylinder.

4. The method according to claim 1, further comprising determining the irregularity in operation of the internal combustion engine based on a difference between the rotational characteristic value of the first sub-powertrain and the rotational characteristic value of the rotor, wherein a torque provided by the internal combustion engine is constant.

5. The method according to claim 2, further comprising determining the difference via a state estimator.

6. The method according to claim 1, wherein the rotational characteristic value of the first sub-powertrain and the rotational characteristic value of the rotor corresponding to a same rotational characteristic, the rotational characteristic being one as a rotational revolutions, a rotational speeds, a rotational acceleration, or a rotational angles.

7. The method according to claim 1, further comprising determining at least one of applied kinetic energy, potential energy, transmitted torques, applied speeds, or rotational accelerations in at least one of the sub-powertrains or the torsional elasticity based on the rotational characteristic values in the first sub-powertrain and the rotational characteristic value in the rotor.

8. The method according to claim 1, wherein the device is a sensor configured to control electronic communication of the electric machine.

9. The method according to claim 1, wherein the device is a state observer configured to control the electric machine based on evaluating electrical variables in a stator of the electric machine.

10. A hybrid powertrain, comprising:
a first sub-powertrain, including an internal combustion engine having a crankshaft;
a second sub-powertrain including an electric machine having a rotor;
a torsional elasticity arranged between the first sub-powertrain and the second sub-powertrain, the torsional elasticity being connected to crankshaft and the rotor;
a sensor arranged on the torsional elasticity and configured to detect a rotational characteristic value of the crankshaft;
a device engaged with the rotor and configured to detect a rotational characteristic value of the rotor; and
a controller in communication in with the sensor and the device, the controller being configured to:
receive the rotational characteristic value of the crankshaft from the sensor;
receive the rotational characteristic value of the rotor from the device;
determine an irregularity in operation of the internal combustion engine based on at least one of the rotational characteristic value of the crankshaft or the rotational characteristic value of the rotor; and
control the electric machine based on the irregularity in operation.

11. The method according to claim 1, further comprising:
detecting the rotational characteristic value of the first sub-powertrain in one cylinder of the internal combustion engine;
after a period of time, detecting a subsequent rotational characteristic value of the first sub-powertrain in the one cylinder; and
determining the irregularity in operation of the internal combustion engine based on a difference between the rotational characteristic value and the subsequent rotational characteristic value exceeding a threshold.

12. The method according to claim 1, wherein the irregularity in operation of the internal combustion engine is one of a misfire, a valve misalignment, or an insufficient fuel injection.

13. The method according to claim 3, wherein the stored ignition curve is adapted based on control variables of the internal combustion engine.

14. The hybrid powertrain according to claim 10, wherein the controller is further configured to:
receive the rotational characteristic value of the first sub-powertrain for at least two consecutive ignition curves in different cylinders of the internal combustion engine; and
determine the irregularity in operation of the internal combustion engine based on a difference between the rotational characteristic values of the first sub-powertrain for the corresponding the ignition curves exceeding a threshold.

15. The hybrid powertrain according to claim 10, wherein the controller is further configured to:
receive the rotational characteristic value of the first sub-powertrain for an ignition curve, of a cylinder; and
determine the irregularity in operation of the internal combustion engine based on a difference between the rotational characteristic value of the first sub-powertrain for the ignition curve of the cylinder and a stored ignition curve of the cylinder.

16. The hybrid powertrain according to claim 15, wherein the stored ignition curve is adapted based on control variables of the internal combustion engine.

17. The hybrid powertrain according to claim 10, wherein the controller is further configured to:
receive the rotational characteristic value of the first sub-powertrain in one cylinder of the internal combustion engine;
after a period of time, receive a subsequent rotational characteristic value of the first sub powertrain in the one cylinder; and
determine the irregularity in operation of the internal combustion engine based on a difference between the rotational characteristic value and the subsequent rotational characteristic value exceeding a threshold.

18. The hybrid powertrain according to claim 10, wherein the controller is further configured to determine the irregularity in operation of the internal combustion engine based on a difference between the rotational characteristic value of the first sub-powertrain and the rotational characteristic value of the rotor, wherein a torque provided by the internal combustion engine is constant.

19. The hybrid powertrain according to claim 10, wherein the irregularity in operation of the internal combustion engine is one of a misfire, a valve misalignment, or an insufficient fuel injection.

20. The hybrid powertrain according to claim 10, wherein the rotational characteristic value of the first sub-powertrain and the rotational characteristic value of the rotor correspond to a same rotational characteristic, and wherein the rotational characteristic is one of a rotational revolution, a rotational speed, a rotational acceleration, or a rotational angle.
